(19) United States
(12) Patent Application Publication
(10) Pub. No.: US 2013/0106891 A1
(43) Pub. Date: May 2, 2013

(54) METHOD OF SUB-PIXEL RENDERING FOR A DELTA-TRIAD STRUCTURED DISPLAY

(71) Applicants: Yojiro Matsueda, Hsinchu (TW); Hsueh-Yen Yang, Hsinchu (TW); Hong-Shen Lin, Hsinchu (TW)

(72) Inventors: Yojiro Matsueda, Hsinchu (TW); Hsueh-Yen Yang, Hsinchu (TW); Hong-Shen Lin, Hsinchu (TW)

(73) Assignee: AU OPTRONICS CORPORATION, Hsinchu (TW)

(21) Appl. No.: 13/286,525

(22) Filed: Nov. 1, 2011

(51) Int. Cl. G09G 5/02; G09G 5/10

(52) U.S. Cl. 345/589; 345/690

(57) ABSTRACT

A method of rendering a color image on a delta-structured color display. The display has a plurality of first sub-pixel groups and a plurality of second sub-pixel groups interlacing with each other. Each first sub-pixel group includes a first sub-pixel of a first color. Each second sub-pixel group includes a second sub-pixel of a second color and a third sub-pixel of a third color. In one embodiment, the method includes inputting the color image, analyzing the color image to estimate one or more patterns of the image, determining one or more color template indexes, each color template indexes corresponding to a respective one of the one or more patterns, generating an intensity map, including an intensity for each first sub-pixel, second sub-pixel, and third sub-pixel of the display, according to the color template indexes, and outputting a plurality of electrical signals according to the intensity map to the display.

### FIELD OF THE INVENTION

The present invention relates generally to an image display, and more particularly, to a method of sub-pixel rendering for a delta-triad arrangement with shared colors in a display.

### BACKGROUND OF THE INVENTION

Display devices employing electroluminescent display elements, such as organic light emitting diodes (OLEDs), have become a popular choice among flat panel displays. OLED displays are used as television screens, computer monitors, portable electronic systems such as mobile phones and personal digital assistants (PDAs). An OLED is a light emitting diode (LED) in which the emissive electroluminescent layer is a film of organic compounds which emit light in response to an electric current. This layer of organic semiconductor material is situated between two electrodes. Generally, at least one of these electrodes is transparent. An OLED display functions without a backlight. Thus, it can display deep black levels and can also be thinner and lighter than other flat panel displays such liquid crystal displays (LCDs). OLED displays can use either passive-matrix (PMOLED) or active-matrix (AMOLED) addressing schemes. AMOLED is more suitable for higher resolution and larger size displays.

An AMOLED display normally comprises a circuit layer formed on a substrate such as glass and an emission layer formed on the circuit layer. The emission layer comprises a plurality of regularly-spaced emission pixels positioned in a display area in a form of a matrix with a plurality of rows and a plurality of columns. For color displays, each emission pixel may further comprise three sub-pixels that emit red, green, and blue (RGB) light, respectively. FIG. 9 illustrates a stripe arrangement of sub-pixels in a conventional color AMOLED display. In this arrangement, each emission pixel (indicated by the dashed square) includes three RGB sub-pixels arranged as an array in the row direction. Each sub-pixel is approximately three times as high as it is wide. Thus each emission pixel has an approximately square shape. Sub-pixels of the same color are arranged as continuous stripes in the column direction.

The circuit layer for a color AMOLED display comprises a plurality of sub-pixel circuits. Each sub-pixel circuit is electrically coupled to a respective sub-pixel for controlling the current through the respective sub-pixel in response to an applied data signal. Each sub-pixel circuit typically includes two or more thin film transistors (TFTs) and thus occupies a significant area on the display. For this reason, the spatial resolution of a color AMOLED display is typically limited to less than or equal to 200 pixels per inch (PPI).

Therefore, a heretofore unaddressed need exists in the art to address the aforementioned deficiencies and inadequacies.

### SUMMARY OF THE INVENTION

The present invention, in one aspect, relates to a method of rendering a color image on a delta-structured color display. The display has a plurality of first sub-pixel groups and a plurality of second sub-pixel groups, where the plurality of second sub-pixel groups is interlaced with the plurality of first sub-pixel groups to form a matrix having a plurality of rows and a plurality of columns. Each of the plurality of first sub-pixel groups includes a first sub-pixel of a first color. Each of the plurality of second sub-pixel groups includes a second sub-pixel of a second color and a third sub-pixel of a third color. The second sub-pixel and the third sub-pixel of each second sub-pixel group are positioned next to each other in the row direction. In one embodiment, the first color is green, the second color is blue, and the third color is red.

In one embodiment, the method includes the steps of inputting the color image, analyzing the color image to estimate one or more patterns of the image, determining one or more color template indexes, each of the one or more color template indexes corresponding to a respective one of the one or more patterns, generating an intensity map, including an intensity for each first sub-pixel, second sub-pixel, and third sub-pixel of the display, according to the one or more color template indexes, and outputting a plurality of electrical signals according to the intensity map to the display.

In one embodiment, when a grayscale value of the color image is equal to or greater than 1, the intensity for each sub-pixel of the green color is greater than zero for each of the one or more color template indexes corresponding to a respective one of the one or more patterns.

In one embodiment, the one or more patterns of the color image include a dot, and the color template index for the dot comprises a first brightness ratio for the first sub-pixel of a first sub-pixel group at a center of the dot, a second brightness ratio for the second sub-pixels and a third brightness ratio for the third sub-pixels of two second sub-pixel groups next to the first sub-pixel group, one of the two second sub-pixel groups being in a row above and the other one of the two second sub-pixel groups being in a row below the first sub-pixel group.

In another embodiment, the one or more patterns of the color image include a dot, and the color template index for the dot comprises a second brightness ratio for the second sub-pixel and a third brightness ratio for the third sub-pixel of a second sub-pixel group at a center of the dot, and a first brightness ratio for the first sub-pixels of two first sub-pixel groups next to the second sub-pixel group, one of the two first sub-pixel groups being in a row above and the other one of the two first sub-pixel groups being in a row below the second sub-pixel group.

In one embodiment, wherein the one or more patterns of the color image include a vertical line, and the color template index for the vertical line comprises a first brightness ratio for the first sub-pixels of two or more first sub-pixel groups in a column, a second brightness ratio for the second sub-pixels and a third brightness ratio for the third sub-pixels of two or more second sub-pixel groups in the same column interlacing with the two or more first sub-pixel groups.

In one embodiment, the one or more patterns of the color image include a horizontal line, and the color template index for the horizontal line comprises a first brightness ratio for the first sub-pixels of two or more first sub-pixel groups in a row, a second brightness ratio for the second sub-pixels and a third brightness ratio for the third sub-pixels of two or more second sub-pixel groups in the same row interlacing with the two or more first sub-pixel groups.

In one embodiment, the one or more patterns of the color image include a diagonal line, and the color template index for the diagonal line comprises a first brightness ratio for the first sub-pixels of two or more first sub-pixel groups in two or more consecutive rows and offset by one sub-pixel group from one row to the next, the color template index further comprises a second brightness ratio for the second sub-pixels of two or more second sub-pixel groups each flanking a respective one of the two or more first sub-pixel groups on a first side in a respective row, the color template index further comprises a third brightness ratio for the third sub-pixels of two or more second sub-pixel groups each flanking a respective one of the two or more first sub-pixel groups on a second side in a respective row.

In another embodiment, the one or more patterns of the color image include a diagonal line, and the color template index for the diagonal line comprises a second brightness ratio for the second sub-pixels and a third brightness ratio for the third sub-pixels of two or more second sub-pixel groups in two or more consecutive rows and offset by one sub-pixel group from one row to the next, the color template index further comprises a first brightness ratio for the first sub-pixels of two or more pairs of first sub-pixel groups, each pair of first sub-pixel groups flanking a respective one of the two or more second sub-pixel groups on both sides in a respective row.

In another aspect, the present invention relates to a driver for a delta-structured color display. The display has a plurality of first sub-pixel groups and a plurality of second sub-pixel groups, where the plurality of second sub-pixel groups are interlaced with the plurality of first sub-pixel groups to form a matrix having a plurality of rows and a plurality of columns. Each of the plurality of first sub-pixel groups comprising a first sub-pixel of a first color, and each of the plurality of second sub-pixel groups comprising a second sub-pixel of a second color and a third sub-pixel of a third color. The second sub-pixel and the third sub-pixel of each second sub-pixel group are positioned next to each other in the row direction. In one embodiment, the first color is green, the second color is blue, and the third color is red.

In one embodiment, the driver includes an image input unit for inputting a color image to be displayed on the display, a pattern estimation unit electrically coupled to the color image input unit for analyzing the color image to estimate one or more patterns of the color image, and determining one or more color template indexes, each of the one or more color template indexes corresponding to a respective one of the one or more patterns, a sub-pixel painting unit electrically coupled to the pattern estimation unit for generating an intensity map including an intensity for each first sub-pixel, second sub-pixel, and third sub-pixel of the display, according to the one or more color template indexes, and an image output unit electrically coupled to the sub-pixel painting unit for outputting a plurality of electrical signals according to the intensity map to the display.

Further, the driver may include a luminance mapping unit electrically coupled between the color image input unit and the pattern estimation unit for creating a luminance map of the color image, wherein the luminance map comprises luminance values for each of the red, green, and blue colors, and an output buffer electrically coupled between the sub-pixel painting unit and the color image output unit for generating the plurality of electrical signals according to the intensity map In one embodiment, when a grayscale value of the color image is equal to or greater than 1, the intensity for each sub-pixel of the green color is greater than zero for each of the one or more color template indexes corresponding to a respective one of the one or more patterns.

In one embodiment, the one or more patterns of the color image include a dot, and the color template index for the dot comprises a first brightness ratio for the first sub-pixel of a first sub-pixel group at a center of the dot, a second brightness ratio for the second sub-pixels and a third brightness ratio for the third sub-pixels of two second sub-pixel groups next to the first sub-pixel group, one of the two second sub-pixel groups being in a row above and the other one of the two second sub-pixel groups being in a row below the first sub-pixel group.

In another embodiment, the one or more patterns of the color image include a dot, and the color template index for the dot comprises a second brightness ratio for the second sub-pixel and a third brightness ratio for the third sub-pixel of a second sub-pixel group at a center of the dot, and a first brightness ratio for the first sub-pixels of two first sub-pixel groups next to the second sub-pixel group, one of the two first sub-pixel groups being in a row above and the other one of the two first sub-pixel groups being in a row below the second sub-pixel group.

In one embodiment, the one or more patterns of the color image include a vertical line, and the color template index for the vertical line comprises a first brightness ratio for the first sub-pixels of two or more first sub-pixel groups in a column, a second brightness ratio for the second sub-pixels and a third brightness ratio for the third sub-pixels of two or more second sub-pixel groups in the same column interlacing with the two or more first sub-pixel groups.

In one embodiment, the one or more patterns of the color image include a horizontal line, and the color template index for the horizontal line comprises a first brightness ratio for the first sub-pixels of two or more first sub-pixel groups in a row, a second brightness ratio for the second sub-pixels and a third brightness ratio for the third sub-pixels of two or more second sub-pixel groups in the same row interlacing with the two or more first sub-pixel groups.

In one embodiment, the one or more patterns of the color image include a diagonal line, and the color template index for the diagonal line comprises a first brightness ratio for the first sub-pixels of two or more first sub-pixel groups in two or more consecutive rows and offset by one sub-pixel group from one row to the next, the color template index further comprises a second brightness ratio for the second sub-pixels of two or more second sub-pixel groups each flanking a respective one of the two or more first sub-pixel groups on a first side in a respective row, the color template index further comprises a third brightness ratio for the third sub-pixels of two or more second sub-pixel groups each flanking a respective one of the two or more first sub-pixel groups on a second side in a respective row.

In another embodiment, the one or more patterns of the color image include a diagonal line, and the color template index for the diagonal line comprises a second brightness ratio for the second sub-pixels and a third brightness ratio for the third sub-pixels of two or more second sub-pixel groups in two or more consecutive rows and offset by one sub-pixel group from one row to the next, the color template index further comprises a first brightness ratio for the first sub-pixels of two or more pairs of first sub-pixel groups, each pair of first sub-pixel groups flanking a respective one of the two or more second sub-pixel groups on both sides in a respective row.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates a delta arrangement of sub-pixels in a color display according to one embodiment of the present invention;

FIG. 2 illustrates a method of rendering a color image on the delta-structured color display shown in FIG. 1 by conceptually dividing the display area into a plurality of first sub-pixel groups and a plurality of second sub-pixel groups according to one embodiment of the present invention;

FIG. 3 shows schematically (a) a first sub-pixel group, and (b) a second sub-pixel group, according to one embodiment of the present invention;

FIG. 4 illustrates a method of generating a color template for a dot (a) with a first sub-pixel group in the center, and (b) with a second sub-pixel group in the center, according one embodiment of the present invention;

FIG. 5 illustrates a method of generating a color template for a vertical line according one embodiment of the present invention;

FIG. 6 illustrates a method of generating a color template for a horizontal line according one embodiment of the present invention;

FIG. 7 illustrates a method of generating a color template for a diagonal line of two embodiments (a) and (b) of the present invention;

FIG. 8 shows a block diagram of a driver for a delta-structured color display according to one embodiment of the present invention; and

FIG. 9 illustrates a stripe arrangement of sub-pixels in a conventional color display.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

As used herein, the terms “gray-level” and “grayscale” are synonyms in the specification and refer to one of (discrete) shades of gray for an image, or an amount of light perceived by a human for the image. If the brightness of the color image is expressed in the form of shades of grey in n bits, n being an integer greater than zero, the gray level takes values from zero representing black, up to (2ⁿ−1) representing white, with intermediate values representing increasingly light shades of gray.

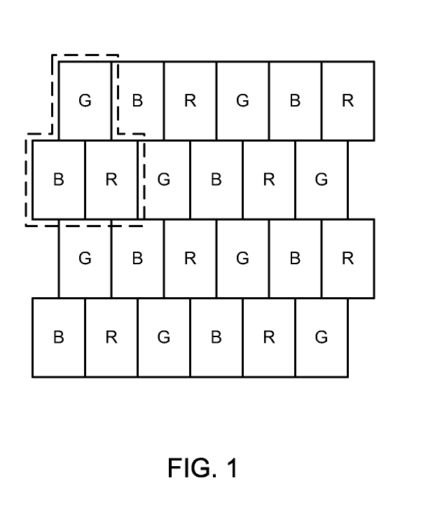

The description will be made as to the embodiments of the present invention in conjunction with the accompanying drawings in FIGS. 1-8. In accordance with the purposes of this invention, as embodied and broadly described herein, this invention, in one aspect, relates to a method of rendering a color image on a delta-structured color display.

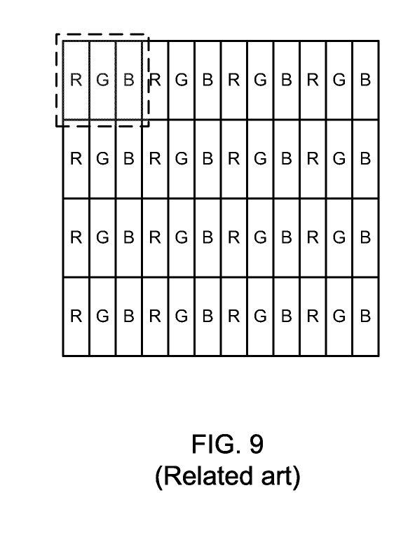

FIG. 1 illustrates a delta arrangement of sub-pixels in a color display according to one embodiment of the present invention. In this arrangement, each sub-pixel has a width-to-height ratio of approximately 2:3. Thus, three adjacent sub-pixels in a row occupy an area equivalent to the area occupied by two pixels (six sub-pixels) in a conventional stripe-structured display shown in FIG. 9. In each row, sub-pixels are arranged as repeating sequences of R-G-B sub-pixels. The sequences in any two consecutive rows are offset by 1.5 pitches with respect to each other, each pitch being the width of a sub-pixel, such that no two sub-pixels of the same color are nearest neighbors with each other. The delta arrangement of sub-pixels shown in FIG. 1 can also be described as an arrangement of groups of three RGB sub-pixels. The three RGB sub-pixels in each group are arranged in a triangular shape (indicated by the dashed outlines, hence the name “delta”). Any two adjacent groups in the row direction are inverted triangles with respect to each other.

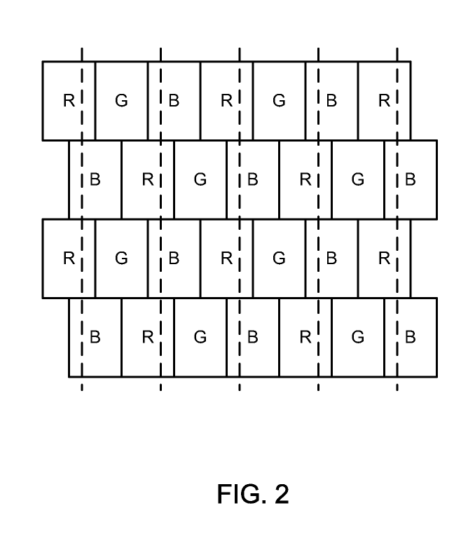

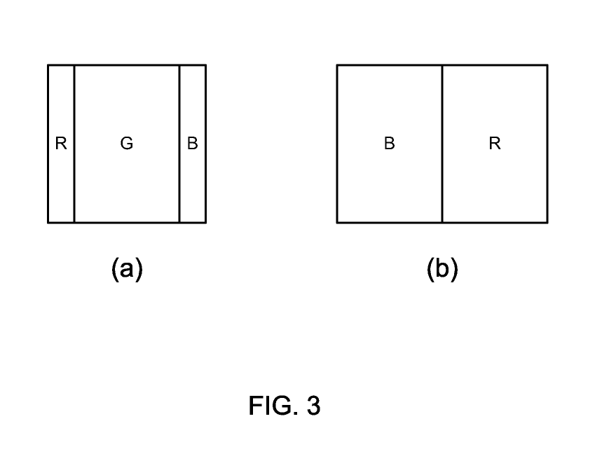

To render a color image on the delta-structured color display shown in FIG. 1, a method of sub-pixel rendering (SPR) is used to take advantage of the delta arrangement. FIG. 2 illustrates a method of rendering a color image on the delta-structured color display shown in FIG. 1 by conceptually dividing the display area into a plurality of first sub-pixel groups and a plurality of second sub-pixel groups, as indicated by the vertical dashed lines, according to one embodiment of the present invention. Each first sub-pixel group comprises a green (G) sub-pixel centered at the first sub-pixel group, as shown in FIG. 3(a). Each second sub-pixel group comprises a blue (B) sub-pixel and a red (R) sub-pixel arranged side by side in the row direction, as shown in FIG. 3(b). The plurality of first sub-pixel groups is interlaced with the plurality of second sub-pixel groups to form a matrix with a plurality of rows and a plurality of columns. The color green is chosen to be the color of the first sub-pixel in the first sub-pixel group because human eyes are most sensitive to green light and a more natural color mixing can be achieved with this choice. Accordingly, when the grayscale value of an input color image is equal to or greater than 1, the intensity for each sub-pixel of the green color is set to be greater than zero. It is understood that other color combinations can also be used.

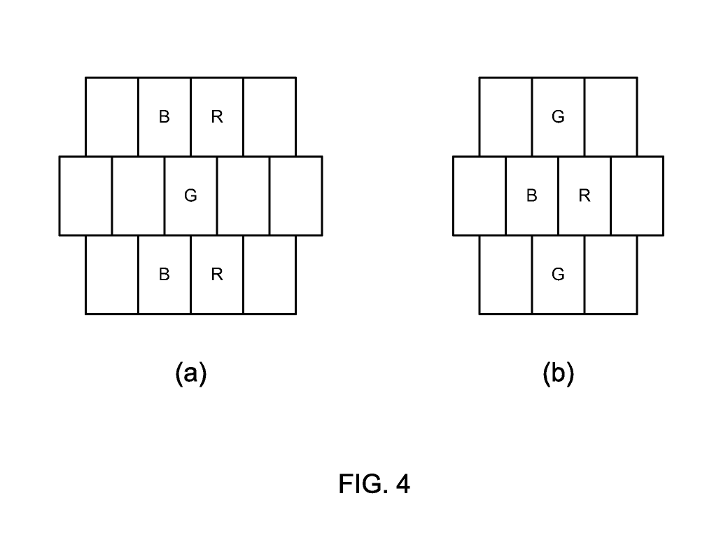

The concept of first sub-pixel group and second sub-pixel group described above is used to generate various color templates for rendering various patterns in an image. FIG. 4(a) illustrates a method of generating a color template for a dot with a first sub-pixel group in the center of the dot according to one embodiment of the present invention. To compensate for the color lacking in the central first sub-pixel group, two second sub-pixel groups, one directly above and the other directly below the central first sub-pixel group, are included for rendering the dot. A color template index is determined according to the color of the dot. The color template index comprises a first brightness ratio for the green sub-pixel in the central first sub-pixel group, a second brightness ratio for a blue sub-pixels and a third brightness ratio for a red sub-pixels in the two second sub-pixel groups. Each of the first, second, and third brightness ratios is the ratio of a grayscale value (brightness) of a respective color to its maximal grayscale value and is expressed as a percentage ranging from 0% to 100%. For example, for an n-bit grayscale of a color, the grayscale value takes values from zero representing no such a color, up to (2ⁿ−1) representing the full color. The former has a brightness ratio of 0%, while the latter has a brightness ratio of 100% of the color. In the following examples of the specification, the brightness ratios are based on an 8-bit color grayscale, i.e., the grayscale value takes from 0, 1, 2, . . . , 254, up to 255. It is understood that other bit grayscales can also be utilized to practice the present invention.

For example, to render a white dot, a color template index may comprise a green brightness ratio of about 100%, a blue brightness ratio ranging from about 50% to about 100%, and a red brightness ratio ranging from about 50% to about 100%. To render a red dot, a color template index may comprise a green brightness ratio ranging from about 1% to about 20%, a blue brightness ratio ranging from about 0% to about 50%, and a red brightness ratio ranging from about 50% to about 100%. To render a green dot, a color template index may comprise a green brightness ratio of about 100%, a blue brightness ratio ranging from about 0% to about 50%, and a red brightness ratio ranging from about 1% to about 30%. To render a blue dot, a color template index may comprise a green brightness ratio ranging from about 1% to about 20%, a blue brightness ratio ranging from about 50% to about 100%, and a red brightness ratio ranging from about 0% to about 30%.

FIG. 4(b) illustrates a method of generating a color template for a dot with a second sub-pixel group in the center of the dot according to another embodiment of the present invention. To compensate for the color lacking in the central second sub-pixel group, two first sub-pixel groups, one directly above and the other directly below the central second sub-pixel group, are included for rendering the dot. Similar to the embodiment described above in reference to FIG. 4(a), a color template index is determined according to the color of the dot. For example, to render a white dot, a color template index may comprise a green brightness ratio ranging from about 50% to about 100%, a blue brightness ratio of about 100%, and a red brightness ratio of about 100%. To render a red dot, a color template index may comprise a green brightness ratio ranging from about 1% to about 20%, a blue brightness ratio ranging from about 0% to about 50%, and a red brightness ratio of about 100%. To render a green dot, a color template index may comprise a green brightness ratio ranging from about 50% to about 100%, a blue brightness ratio ranging from about 0% to about 50%, and a red brightness ratio ranging from about 1% to about 30%. To render a blue dot, a color template index may comprise a green brightness ratio ranging from about 1% to about 20%, a blue brightness ratio of about 100%, and a red brightness ratio ranging from about 0% to about 30%.

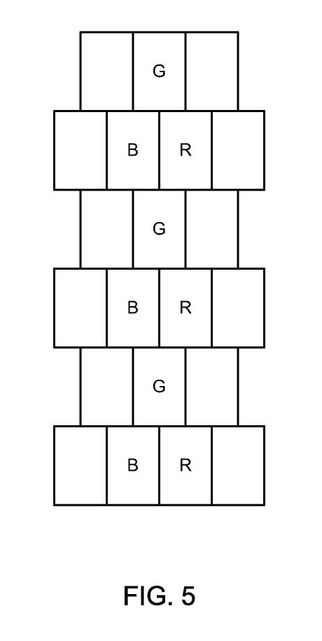

FIG. 5 illustrates a method of generating a color template for a vertical line according to one embodiment of the present invention. The vertical line is rendered by two or more first sub-pixel groups in a column and two or more second sub-pixel groups in the same column interlacing with the two or more first sub-pixel groups. A color template index is determined according to the color of the vertical line. For example, to render a white vertical line, a color template index may comprise a green brightness ratio of about 100%, a blue brightness ratio ranging from about 50% to about 100%, and a red brightness ratio ranging from about 50% to about 100%. To render a red vertical line, a color template index may comprise a green brightness ratio ranging from about 1% to about 20%, a blue brightness ratio ranging from about 0% to about 50%, and a red brightness ratio of about 100%. To render a green vertical line, a color template index may comprise a green brightness ratio of about 100%, a blue brightness ratio ranging from about 0% to about 50%, and a red brightness ratio ranging from about 1% to about 30%. To render a blue vertical line, a color template index may comprise a green brightness ratio ranging from about 1% to about 20%, a blue brightness ratio of about 100%, and a red brightness ratio ranging from about 0% to about 30%.

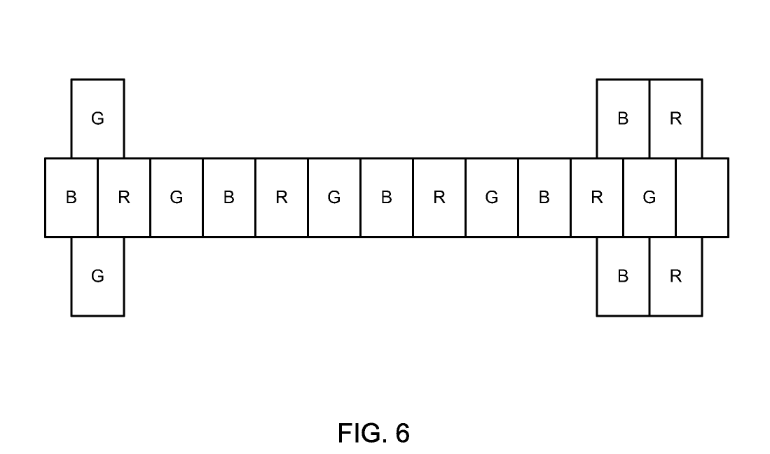

FIG. 6 illustrates a method of generating a color template for a horizontal line according to one embodiment of the present invention. The horizontal line is rendered by two or more first sub-pixel groups in a row, and two or more second sub-pixel groups in the same row interlacing with the two or more first sub-pixel groups. To compensate for the color lacking at each end of the horizontal line, two additional first sub-pixel groups, one directly above and the other one directly below a second sub-pixel group at an end of the horizontal line, and two additional second sub-pixel groups, one directly above and the other one directly below a first sub-pixel group at the other end of the horizontal line, are also included for rendering the horizontal line. A color template index is determined according to the color of the horizontal line. For example, to render a white horizontal line, a color template index may comprise a green brightness ratio ranging from about 50% to about 100%, a blue brightness ratio ranging from about 50% to about 100%, and a red brightness ratio ranging from about 50% to about 100%. To render a red horizontal line, a color template index may comprise a green brightness ratio ranging from about 1% to about 20%, a blue brightness ratio ranging from about 0% to about 50%, and a red brightness ratio ranging from about 50% to about 100%. To render a green horizontal line, a color template index may comprise a green brightness ratio ranging from about 50% to about 100%, a blue brightness ratio ranging from about 1% to about 50%, and a red brightness ratio ranging from about 1% to about 30%. To render a blue horizontal line, a color template index may comprise a green brightness ratio ranging from about 1% to about 10%, a blue brightness ratio ranging from about 50% to about 100%, and a red brightness ratio ranging from about 0% to about 30%.

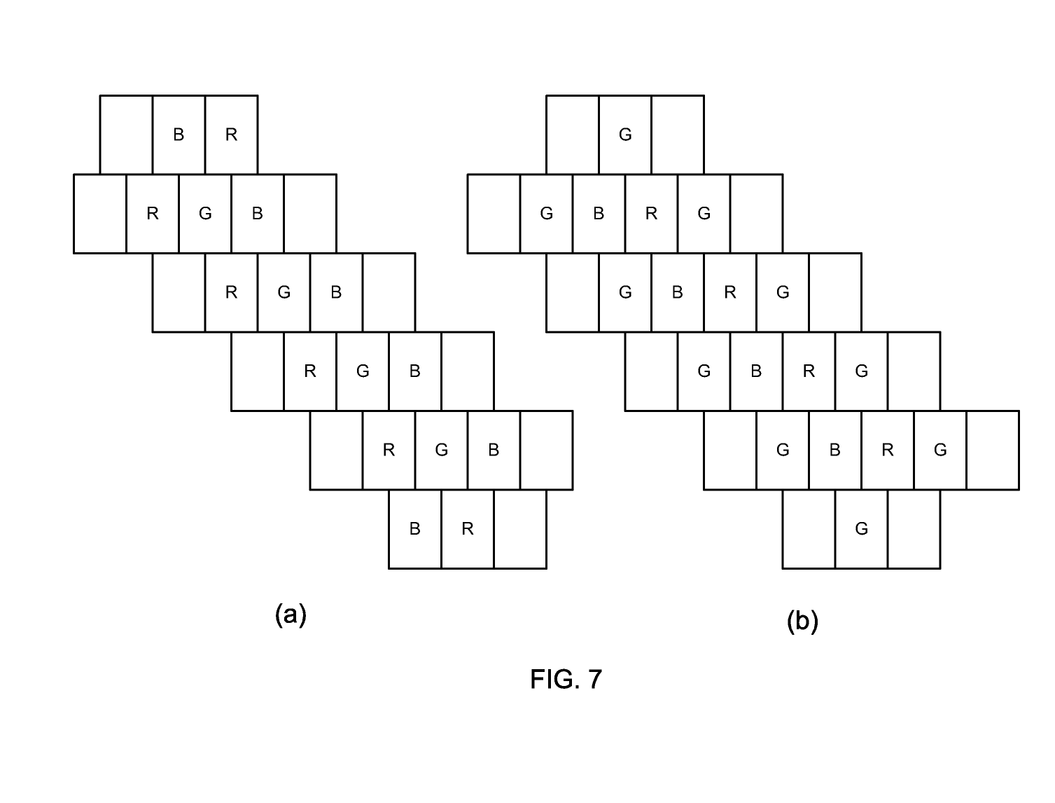

FIG. 7(a) illustrates a method of generating a color template for a diagonal line according to one embodiment of the present invention. The diagonal line is rendered by two or more first sub-pixel groups in two or more consecutive rows and offset by 1.5 pitches from one row to the next. To compensate for the color lacking in the two or more first sub-pixel groups, the red sub-pixels of two or more second sub-pixel groups each flanking a respective one of the two or more first sub-pixel groups on the left side in a respective row, and the blue sub-pixels of two or more second sub-pixel groups each flanking a respective one of the two or more first sub-pixel groups on the right side in a respective row are included for rendering the diagonal line. In addition, to compensate for the color lacking each end of the diagonal line, two additional second sub-pixel groups, one directly above the top first sub-pixel group and the other one directly below the bottom first sub-pixel group, are also included. A color template index is determined according to the color of the diagonal line. For example, to render a white diagonal line, a color template index may comprise a green brightness ratio of about 100%, a blue brightness ratio ranging from about 50% to about 100%, and a red brightness ratio ranging from about 50% to about 100%. To render a red horizontal line, a color template index may comprise a green brightness ratio ranging from about 1% to about 20%, a blue brightness ratio ranging from about 0% to about 50%, and a red brightness ratio of about 100%. To render a green horizontal line, a color template index may comprise a green brightness ratio ranging from about 50% to about 100%, a blue brightness ratio ranging from about 0% to about 50%, and a red brightness ratio ranging from about 1% to about 30%. To render a blue horizontal line, a color template index may comprise a green brightness ratio ranging from about 1% to about 20%, a blue brightness ratio of about 100%, and a red brightness ratio ranging from about 0% to about 30%.

FIG. 7(b) illustrates a method of generating a color template for a diagonal line according to another embodiment of the present invention. The diagonal line is rendered by two or more second sub-pixel groups in two or more consecutive rows and offset by 1.5 pitches from one row to the next. To compensate for the color lacking in the two or more second sub-pixel groups, two or more pairs of first sub-pixel groups each pair flanking a respective one of the two or more second sub-pixel groups on both the left side and the right side in a respective row are included for rendering the diagonal line. In addition, to compensate for the color lacking at each end of the diagonal line, two additional first sub-pixel groups, one directly above the top second sub-pixel group and the other one directly below the bottom second sub-pixel group, are also included. A color template index is determined according to the color of the diagonal line. For example, to render a white diagonal line, a color template index may comprise a green brightness ratio ranging from about 50% to about 100%, a blue brightness ratio of about 100%, and a red brightness ratio of about 100%. To render a red diagonal line, a color template index may comprise a green brightness ratio ranging from about 1% to about 20%, a blue brightness ratio ranging from about 0% to about 50%, and a red brightness ratio of about 100%. To render a green diagonal line, a color template index may comprise a green brightness ratio ranging from about 50% to about 100%, a blue brightness ratio ranging from about 0% to about 50%, and a red brightness ratio ranging from about 1% to about 30%. To render a blue diagonal line, a color template index may comprise a green brightness ratio ranging from about 1% to about 20%, a blue brightness ratio of about 100%, and a red brightness ratio ranging from about 0% to about 30%.

According to the present invention, as described above, for each color template index, the green brightness ratio is greater than 0%.

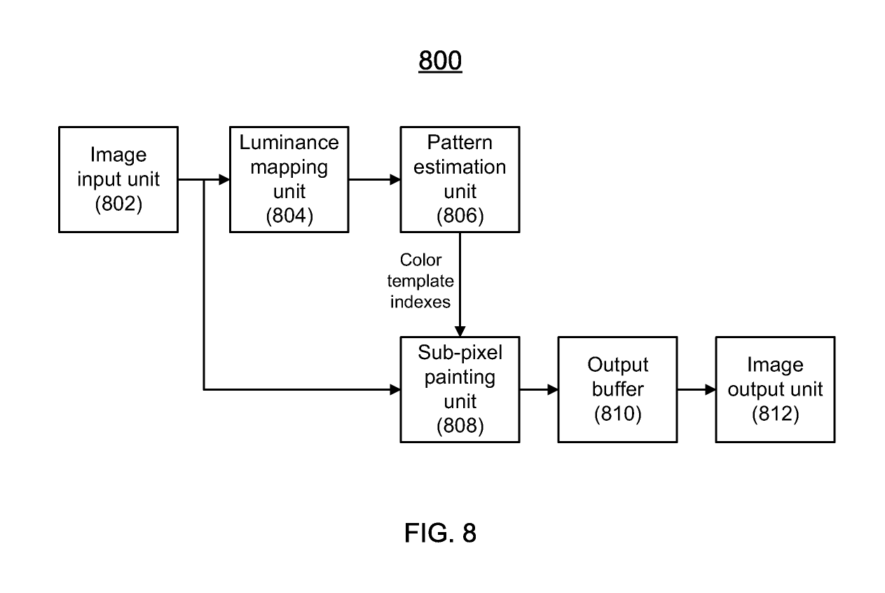

FIG. 8 shows a block diagram of a driver 800 configured to render a color image on a delta-structured color display according to one embodiment of the present invention. The driver 800 includes an image input unit 802, a luminance mapping unit 804, a pattern estimation unit 806, a sub-pixel painting unit 808, an output buffer 810, and an image output unit 812. The color image input unit 802 is configured to input an image to be displayed on the color display. A luminance map is created for the color image by the luminance mapping unit 804. The luminance map includes luminance values for each of the red, green, and blue colors. The luminance map is analyzed by the pattern estimation unit 806 to estimate one or more patterns of the image. The one or more patterns of the color image include at least one of a dot, a vertical line, a horizontal line, or a diagonal line. The pattern estimation unit 806 also generates one or more color template indexes for each of the patterns. The sub-pixel painting unit 808 creates an intensity map according to the one or more color template indexes, and outputs the intensity map data to the output buffer 810. The intensity map includes an intensity value for each first sub-pixel, second sub-pixel, and third sub-pixel of the display. The output buffer 810 outputs a plurality of voltage signals according to the intensity map data to the display via the color image output unit 812. The driver 800 is also configured to create an intensity map directly from the inputted image without using the luminance mapping unit 804 and the pattern estimation unit 806.

In summary, a method of rendering a color image on a delta-structured color display is described in various embodiments. By conceptually dividing the display area into a plurality of green-centered first sub-pixel groups and a plurality of red-blue second sub-pixel groups interlaced with the plurality of first sub-pixels groups, natural color mixing and high apparent spatial resolution can be realized. Although the method is described in the context of an AMOLED color display, it is understood that it can also be used for other types of color displays such as liquid crystal displays.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method of rendering a color image on a delta-structured color display, the display comprising a plurality of first sub-pixel groups and a plurality of second sub-pixel groups, the plurality of second sub-pixel groups being interlaced with the plurality of first sub-pixel groups to form a matrix having a plurality of rows and a plurality of columns, each of the plurality of first sub-pixel groups comprising a first sub-pixel of a first color, each of the plurality of second sub-pixel groups comprising a second sub-pixel of a second color and a third sub-pixel of a third color, the second sub-pixel and the third sub-pixel of each second sub-pixel group being positioned next to each other in the row direction, the method comprising the steps of:
(a) inputting the color image;
(b) analyzing the color image to estimate one or more patterns of the color image;
(c) determining one or more color template indexes, each of the one or more color template indexes corresponding to a respective one of the one or more patterns;
(d) generating an intensity map, including an intensity for each first sub-pixel, second sub-pixel, and third sub-pixel of the display, according to the one or more color template indexes; and
(e) outputting a plurality of electrical signals according to the intensity map to the display.

2. The method of claim 1, wherein the first color is green, the second color is blue, and the third color is red.

3. The method of claim 2, wherein when a grayscale value of the color image is equal to or greater than 1, the intensity for each sub-pixel of the green color is greater than zero for each of the one or more color template indexes corresponding to a respective one of the one or more patterns.

4. The method of claim 1, wherein the one or more patterns of the color image include a dot, and wherein the color template index for the dot comprises a first brightness ratio for the first sub-pixel of a first sub-pixel group at a center of the dot, a second brightness ratio for the second sub-pixels and a third brightness ratio for the third sub-pixels of two second sub-pixel groups next to the first sub-pixel group, one of the two second sub-pixel groups being in a row above the first sub-pixel group and the other one of the two second sub-pixel groups being in a row below the first sub-pixel group.

5. The method of claim 1, wherein the one or more patterns of the color image include a dot, and wherein the color template index for the dot comprises a second brightness ratio for the second sub-pixel and a third brightness ratio for the third sub-pixel of a second sub-pixel group at a center of the dot, and a first brightness ratio for the first sub-pixels of two first sub-pixel groups next to the second sub-pixel group, one of the two first sub-pixel groups being in a row above the second sub-pixel group and the other one of the two first sub-pixel groups being in a row below the second sub-pixel group.

6. The method of claim 1, wherein the one or more patterns of the color image include a vertical line, and wherein the color template index for the vertical line comprises a first brightness ratio for the first sub-pixels of two or more first sub-pixel groups in a column, a second brightness ratio for the second sub-pixels and a third brightness ratio for the third sub-pixels of two or more second sub-pixel groups in the same column interlacing with the two or more first sub-pixel groups.

7. The method of claim 1, wherein the one or more patterns of the color image include a horizontal line, and wherein the color template index for the horizontal line comprises a first brightness ratio for the first sub-pixels of two or more first sub-pixel groups in a row, a second brightness ratio for the second sub-pixels and a third brightness ratio for the third sub-pixels of two or more second sub-pixel groups in the same row interlacing with the two or more first sub-pixel groups.

8. The method of claim 1, wherein the one or more patterns of the color image include a diagonal line, and wherein the color template index for the diagonal line comprises a first brightness ratio for the first sub-pixels of two or more first sub-pixel groups in two or more consecutive rows and offset by one sub-pixel group from one row to the next, the color template index further comprises a second brightness ratio for the second sub-pixels of two or more second sub-pixel groups each flanking a respective one of the two or more first sub-pixel groups on a first side in a respective row, the color template index further comprises a third brightness ratio for the third sub-pixels of two or more second sub-pixel groups each flanking a respective one of the two or more first sub-pixel groups on a second side in a respective row.

9. The method of claim 1, wherein the one or more patterns of the color image include a diagonal line, and wherein the color template index for the diagonal line comprises a second brightness ratio for the second sub-pixels and a third brightness ratio for the third sub-pixels of two or more second sub-pixel groups in two or more consecutive rows and offset by one sub-pixel group from one row to the next, the color template index further comprises a first brightness ratio for the first sub-pixels of two or more pairs of first sub-pixel groups, each pair of first sub-pixel groups flanking a respective one of the two or more second sub-pixel groups on both sides in a respective row.

10. A driver for a delta-structured color display, the display comprising a plurality of first sub-pixel groups and a plurality of second sub-pixel groups, the plurality of second sub-pixel groups being interlaced with the plurality of first sub-pixel groups to form a matrix having a plurality of rows and a plurality of columns, each of the plurality of first sub-pixel groups comprising a first sub-pixel of a first color, each of the plurality of second sub-pixel groups comprising a second sub-pixel of a second color and a third sub-pixel of a third color, the second sub-pixel and the third sub-pixel of each second sub-pixel group being positioned next to each other in the row direction, the driver comprises:
(a) an image input unit for inputting a color image to be displayed on the display;
(b) a pattern estimation unit electrically coupled to the color image input unit for analyzing the color image to estimate one or more patterns of the color image, and determining one or more color template indexes, each of the one or more color template indexes corresponding to a respective one of the one or more patterns;
(c) a sub-pixel painting unit electrically coupled to the pattern estimation unit for generating an intensity map including an intensity for each first sub-pixel, second sub-pixel, and third sub-pixel of the display, according to the one or more color template indexes; and
(d) an image output unit electrically coupled to the sub-pixel painting unit for outputting a plurality of electrical signals according to the intensity map to the display.

11. The driver of claim 10, wherein the first color is green, the second color is blue, and the third color is red.

12. The driver of claim 11, wherein when the grayscale value of the color image is equal to or greater than 1, the intensity for each sub-pixel of the green color is greater than zero for each of the one or more color template indexes corresponding to a respective one of the one or more patterns.

13. The driver of claim 10, wherein the one or more patterns of the color image include a dot, and wherein the color template index for the dot comprises a first brightness ratio for the first sub-pixel of a first sub-pixel group at a center of the dot, a second brightness ratio for the second sub-pixels and a third brightness ratio for the third sub-pixels of two second sub-pixel groups next to the first sub-pixel group, one of the two second sub-pixel groups being in a row above and the other one of the two second sub-pixel groups being in a row below the first sub-pixel group.

14. The driver of claim 10, wherein the one or more patterns of the color image include a dot, and wherein the color template index for the dot comprises a second brightness ratio for the second sub-pixel and a third brightness ratio for the third sub-pixel of a second sub-pixel group at a center of the dot, and a first brightness ratio for the first sub-pixels of two first sub-pixel groups next to the second sub-pixel group, one of the two first sub-pixel groups being in a row above and the other one of the two first sub-pixel groups being in a row below the second sub-pixel group.

15. The driver of claim 10, wherein the one or more patterns of the color image include a vertical line, and wherein the color template index for the vertical line comprises a first brightness ratio for the first sub-pixels of two or more first sub-pixel groups in a column, a second brightness ratio for the second sub-pixels and a third brightness ratio for the third sub-pixels of two or more second sub-pixel groups in the same column interlacing with the two or more first sub-pixel groups.

16. The driver of claim 10, wherein the one or more patterns of the color image include a horizontal line, and wherein the color template index for the horizontal line comprises a first brightness ratio for the first sub-pixels of two or more first sub-pixel groups in a row, a second brightness ratio for the second sub-pixels and a third brightness ratio for the third sub-pixels of two or more second sub-pixel groups in the same row interlacing with the two or more first sub-pixel groups.

17. The driver of claim 10, wherein the one or more patterns of the color image include a diagonal line, and wherein the color template index for the diagonal line comprises a first brightness ratio for the first sub-pixels of two or more first sub-pixel groups in two or more consecutive rows and offset by one sub-pixel group from one row to the next, the color template index further comprises a second brightness ratio for the second sub-pixels of two or more second sub-pixel groups each flanking a respective one of the two or more first sub-pixel groups on a first side in a respective row, the color template index further comprises a third brightness ratio for the third sub-pixels of two or more second sub-pixel groups each flanking a respective one of the two or more first sub-pixel groups on a second side in a respective row.

18. The driver of claim 10, wherein the one or more patterns of the color image include a diagonal line, and wherein the color template index for the diagonal line comprises a second brightness ratio for the second sub-pixels and a third brightness ratio for the third sub-pixels of two or more second sub-pixel groups in two or more consecutive rows and offset by one sub-pixel group from one row to the next, the color template index further comprises a first brightness ratio for the first sub-pixels of two or more pairs of first sub-pixel groups, each pair of first sub-pixel groups flanking a respective one of the two or more second sub-pixel groups on both sides in a respective row.

19. The driver of claim 10, further comprising a luminance mapping unit electrically coupled between the color image input unit and the pattern estimation unit for creating a luminance map of the color image, wherein the luminance map comprises luminance values for each of the red, green, and blue colors.

20. The driver of claim 10, further comprising an output buffer electrically coupled between the sub-pixel painting unit and the color image output unit for generating the plurality of electrical signals according to the intensity map.
